(19) United States
(12) Patent Application Publication
(10) Pub. No.: US 2014/0058987 A1
(43) Pub. Date: Feb. 27, 2014

(54) MoRPE: a machine learning method for probabilistic classification based on monotonic regression of a polynomial expansion

(71) Applicant: Almon David Ing, Redmond, WA (US)

(72) Inventor: Almon David Ing, Redmond, WA (US)

(21) Appl. No.: 13/573,150

(22) Filed: Aug. 27, 2012

(51) Int. Cl. G06F 15/18

(52) U.S. Cl. 706/13; 706/12

(57) ABSTRACT

The classification problem is commonly encountered when a finite sample of data is leveraged to determine the probabilistic relationship between a category label c and a multivariate coordinate x for an entire population. Solving this problem requires approximating the optimal classifier, a function of x that evaluates the conditional probability p(c|x) in an optimal way. This patent describes a new method, machine, and algorithm named MoRPE. MoRPE can be used to approximate optimal classifiers. MoRPE is a machine learning method for probabilistic classification based on Monotonic Regression of a Polynomial expansion. MoRPE can easily understood in terms of the differences between MoRPE and another commonly understood method known as Fisher's Quadratic Discriminant. MoRPE can approximate an optimal classifier with remarkable and unprecedented precision in common scenarios.

### FEDERALLY SPONSORED RESEARCH

This research was sponsored by NIH Grant EY11747. The research was conducted at the University of Texas at Austin. The NIH and the University of Texas at Austin have granted permission to release this patent to its two inventors, Almon D. Ing and Wilson S. Geisler.

### CROSS-REFERENCE TO RELATED APPLICATIONS

Not Applicable

### SEQUENCE LISTING OR PROGRAM

Not Applicable

### FIELD OF THE INVENTION

This invention is related to machine learning methods that learn to classify input signals by assigning the probability of category membership based on the given input signal.

### BACKGROUND OF THE INVENTION

The invention shall be referred to as MoRPE. MoRPE is a method, machine, or algorithm. More specifically, MoRPE is a probabilistic classifier (defined below), it is a supervised machine learning method (defined below), and it can be applied to solve the general probabilistic classification problem (defined below).

A probabilistic classifier is a method, machine, or algorithm that makes a decision about a given input signal by categorizing that signal. More specifically, the probabilistic classifier accepts a signal as input and then outputs a probability of category membership for all enumerated categories. The probabilistic classifier is also a general method, machine, or algorithm that operates across the range of specific applications. For example, a probabilistic classifier could be attached to the optical system of an Unmanned Aerial Vehicle (UAV) to detect targets of interest on the ground below. For each image region viewed by the UAV, the probabilistic classifier would assign the probability of category membership to two categories, “target present” and “target absent.” The same logic can be applied for a machine that detects cancer in mammograms by assigning the probability of “cancer present” and “cancer absent” to a region of a mammogram. The same logic can be applied for a machine that detects email spam by assigning the probability of “spam present” and “spam absent” to any given email. The probabilistic classifier is also a useful tool for use by data analysts to measure, determine, and study the statistical relationship between a class of input signals and a class of category labels.

A supervised machine learning method is any method, machine, or algorithm that learns to make inferences by utilizing a sample of training data. The training data includes a sample of input signals where each input signal is matched to the known output of a method that is either omniscient or is assumed to be omniscient. After training, the method can be used to assign output to new input signals that are not part of the training set. If the method is a classifier (which MoRPE is), then the omniscient output is represented by a unique category label correctly matched to each given input signal.

The probabilistic classification problem is commonly encountered when a finite sample of data must be leveraged to determine the probabilistic relationship between a category label c and a multivariate coordinate x for the entire population from which the sample was drawn. Creating an approximate solution to this problem is equivalent to approximating the optimal classifier. In the context of this patent, the optimal classifier is defined as any function of x that evaluates the conditional probability p(c|x) in an optimal way.

MoRPE is a method that learns to approximate the optimal classifier based on a finite sample of data called the training sample. After MoRPE learns to do this, it can be applied to assign conditional probabilities of category membership for a new sample of input signals that were not part of the original training sample.

Throughout the entire length of this document, algebraic notation is used. This algebra can be interpreted by experts in the fields of machine learning and statistics. The algebra contained herein is based on a style and interpretation similar to a book entitled “Numerical Recipes in C++” published by MIT Press in 2002 by authors Press et al. The algebra contained herein may involve English and Greek characters. Characters printed in normal bold-faced print are typically vectors or matrices whereas characters printed in italics are typically scalars. A distinction is made between lowercase, uppercase, bold, and non-bold characters. Subscripts are used to index the value of a variable as it relates to the values of other variables. In some cases, a subscript may have an underscore character “_” which implies a double-subscript notation. For example, in order to index the variable d with another subscripted variable Q_{κ}, a double-subscript notation involving the underscore character “_” would appear as d_{Q}_{_{—}}_{κ}.

MoRPE can be understood in terms of another method called the Fisher Quadratic Discriminant (FQD). The FQD is a standard method known to experts in the field. The FQD was proposed by R A Fisher in a paper published in the Annals of Eugenics in 1936 entitled “The use of multiple measurements in taxonomic problems.” The best description of the FQD can be found near page 463 in a book by F G Ashby published in 1992 by Erlbaum in Hillsdale, N.J. entitled “Multidimensional models of categorization.” On page 462 and 463 of his book, Ashby refers to the FQD as “the optimal classifier.”

The FQD is the optimal probabilistic classifier in the case of a 2-category classification problem where the categories {1,2} of input signals are distributed as Gaussian for each category, where we know the population mean vectors for both categories, and where we know the population covariance matrices for both categories. In practice, the FQD is often suboptimal. The population statistics must be approximated from a finite training sample using traditional methods. We denote the sample means as two vectors {μ₁,μ₂} and we denote the sample covariance matrices as two matrices {Σ₁,Σ₂}. Both covariance matrices have determinants denoted as {|Σ₁|,|Σ₂|} and matrix inversions denoted as {Σ₁⁻¹,Σ₂⁻¹}. The input signal is given as a 1-column vector x. We can transpose x into become a 1-row vector denoted as x^{T}. The length the input signal vector x is called the dimensionality of the classification problem. The dimensionality is denoted as an integer D.

The FQD can be evaluated in three steps denoted with standard matrix algebra below. The first step for the FQD is to compute y by evaluating the rank-2 inhomogeneous polynomial function of x defined by equation 1. The second step evaluates a logistic sigmoid transform of y as f(y) defined by equation 2. The third step is to assert that the conditional probability of membership in category 1 given x is approximately equal to f(y), as shown in equation 3.

$$\begin{matrix}y ≡ \frac{1}{2} {x}^{T} ( {\sum }_{1}^{- 1} - {\sum }_{2}^{- 1} ) x + ( {μ}_{2}^{T} {\sum }_{2}^{- 1} - {μ}_{1}^{T} {\sum }_{1}^{- 1} ) x + {μ}_{1}^{T} {\sum }_{1}^{- 1} {μ}_{1} + {μ}_{2}^{T} {\sum }_{2}^{- 1} {μ}_{2} + ln \frac{\vert {\sum }_{1} \vert}{\vert {\sum }_{2} \vert} & ( 1 ) \\ f ( y ) = \frac{1}{1 + exp ( - y )} & ( 2 ) \\ p ( 1 \vert x ) \approx f ( y ) & ( 3 )\end{matrix}$$

The definition of y provided above is always used for the FQD model. However, MoRPE will assert a different definition of y.

FIGS. 1A-1D illustrate an example of a training sample and its relationship to the FQD trained on that sample. These illustrations depict an example where the input signal is represented in a 2-dimensional input space based on the assumption that the length of x is 2. In general, the FQD can be applied for input signals of any dimensionality to match any length of x. FIG. 1A illustrates a scatterplot of the training sample which contains 2 categories of input signals. FIG. 1B illustrates the estimation of sample means (filled symbols) and covariance matrices (ovals) where all points along the quadratic curve are defined as y=0. FIG. 1C is a temperature plot of the value of y which is a rank-2 inhomogeneous polynomial function of x. FIG. 1D shows the logistic sigmoid transform of y as a function of x.

Unlike the FQD which must use a rank-2 inhomogeneous polynomial expansion to compute y, MoRPE can use a rank-R inhomogeneous polynomial expansion to compute y where R is a free parameter that controls the complexity of the relationship between MoRPE and the input space.

Unlike the FQD, MoRPE utilizes a technique called monotonic regression. In a monotonic regression problem, a vector v containing Q numbers (v₁, . . . , v_{Q}) is provided as input to an algorithm that performs the regression. On output, the algorithm provides a vector m containing Q numbers (m₁, . . . , m_{Q}) where the values of m are approximately equal to the values of v, but where m is subject to the constraint that its elements be monotonically increasing such that m₁<m₂, . . . , m_{Q-1}<m_{Q}. Thus, the vector m is computed by monotonic regression of v. A custom algorithm for performing monotonic regression was created specifically for MoRPE.

FIG. 2 illustrates an example of the procedure of monotonic regression for a sample case where Q=100. In practice, Q can be any integer greater than 1. In this example, the values of input v are illustrated as a choppy curve. The values of output m are illustrated by the smooth curve with values increasing monotonically as a function of the index.

### SUMMARY

MoRPE is a supervised machine learning method (defined earlier) which yields a probabilistic classifier (defined earlier) which then yields an approximate solution to the general probabilistic classification problem (defined earlier) for any given application of the problem.

For the purpose of clarity and simplicity, MoRPE will be defined in terms of three differences with the FQD. While we define MoRPE in relation to the FQD, it is also true that MoRPE is a unique method that inherits little from the FQD. Conceptually, MoRPE is different from the FQD in three ways.

First, whereas the FQD utilizes a rank-2 inhomogeneous polynomial function of x as shown in equation 1, MoRPE has the flexibility to choose a polynomial of any rank to define the intermediate variable y.

Second, whereas the FQD utilizes a logistic sigmoid function of y to estimate p(1|x) as shown by equations 2 and 3, MoRPE uses a procedure that involves quantization and monotonic regression to estimate p(1|x) as a function of y.

Third, whereas the FQD determines the polynomial coefficients by estimating sample means and covariance matrices, MoRPE determines the polynomial coefficients using a parameter optimization algorithm which seeks to minimize conditional entropy of the training sample (defined later) which is equivalent to maximizing A (defined later).

MoRPE is a method, machine, or algorithm that is operated by a user. The user is defined as a human being or another method, machine, or algorithm that uses MoRPE. The user should operate MoRPE in two epochs: (1) Training and (2) implementation. During the training epoch, MoRPE optimizes its parameters with respect to a training sample provided by the user. During the implementation epoch, MoRPE can make decisions for novel input signals without referencing the training sample. MoRPE must complete the training epoch before the implementation epoch can begin.

MoRPE is a method, machine, or algorithm that approximates a solution to a user's M-category probabilistic classification problem for any M≧2 where M is the number of categories and where a category label c is an integer from the set {1, . . . , M}.

FIG. 3 provides an overview of the computations that MoRPE performs during the training epoch. It illustrates the training sample which the user provides to MoRPE. Each training datum is depicted as a row in a table. Each i-th training datum consists of a category label cᵢ and a feature vector xᵢ . The user also provides MoRPE with the value of R, a positive integer defined later. Using this information, MoRPE computes another positive integer H, also defined later. MoRPE utilizes coefficients, denoted by the letter a with subscripts, which it learns automatically from the training sample. In this document, these coefficients which are denoted by the letter a with subscripts will also be referred to as “polynomial coefficients.” MoRPE uses these polynomial coefficients to process each i-th training datum into a vector yᵢ. After a series of computations, MoRPE computes a vector ρᵢ for each i-th training sample. Finally, MoRPE combines cᵢ and ρᵢ across all training samples to compute λ. The training epoch includes an optimization algorithm which optimizes the polynomial coefficients in order to maximize λ, then it saves the polynomial coefficients for use during the implementation epoch. The algorithm also saves lookup tables depicted in FIG. 4.

FIG. 4 depicts lookup tables which are used to compute vectors ρᵢ from yᵢ across all i. During the training epoch, MoRPE builds these lookup tables using techniques related to quantization and monotonic regression. The lookup tables are evaluated using a technique related to linear interpolation. During training, new lookup tables must be generated each time the polynomial coefficients are altered and these lookup tables are saved at the end of training.

The lookup tables in FIG. 4 are derived from a procedure called quantization (described later). FIG. 5 illustrates an example of quantile boundaries for a sample 2D classification problem with 2 categories. In the illustration, each quantile boundary is depicted as a contour and projected onto x-space. The figure makes it obvious that probability of category membership can be estimated as a function of x by referencing the quantile for a given x and then evaluating the proportion of training samples from a given category within the quantile. MoRPE uses a refined version of this approach to estimate probability. Specifically, MoRPE utilizes monotonic regression to diminish a source of error related to the quantization procedure, then MoRPE builds lookup tables that can be referenced using linear interpolation, and this tends to yield a very precise estimate of probability as a function of x (assuming the polynomial coefficients can be well chosen).

### DRAWINGS—FIGURES

FIG. 1A illustrates a scatterplot which demonstrates an example of the classification problem for 2 categories where the length of x is 2.

FIG. 1B illustrates multivariate Gaussians as iso-density ellipsoids separated by a quadratic decision boundary.

FIG. 1C illustrates a temperature plot of the Fisher Quadratic Discriminant for the training sample, as given by equation 1.

FIG. 1D illustrates the logistic sigmoid transform of the function in FIG. 1C.

FIG. 2 illustrates monotonic regression and some properties the custom algorithm used by MoRPE to perform monotonic regression.

FIG. 3 illustrates the dependencies that govern the training of a MoRPE classifier.

FIG. 4 illustrates the lookup tables that MoRPE uses to perform important calculations.

FIG. 5 illustrates a view of how MoRPE creates quantiles that subtend regions of x-space for an example of the classification with 2 categories where the length of x is 2.

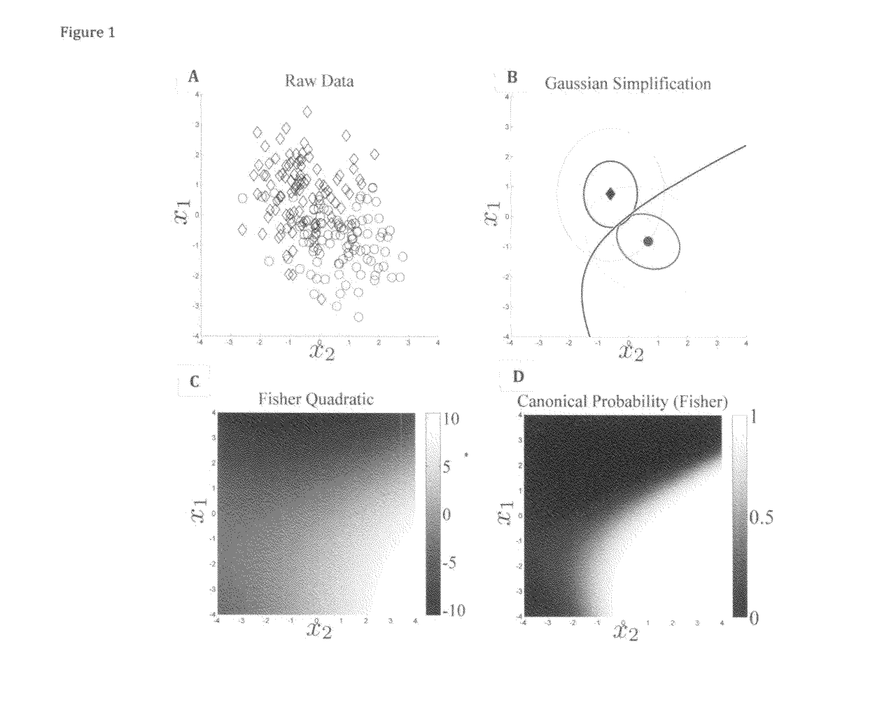

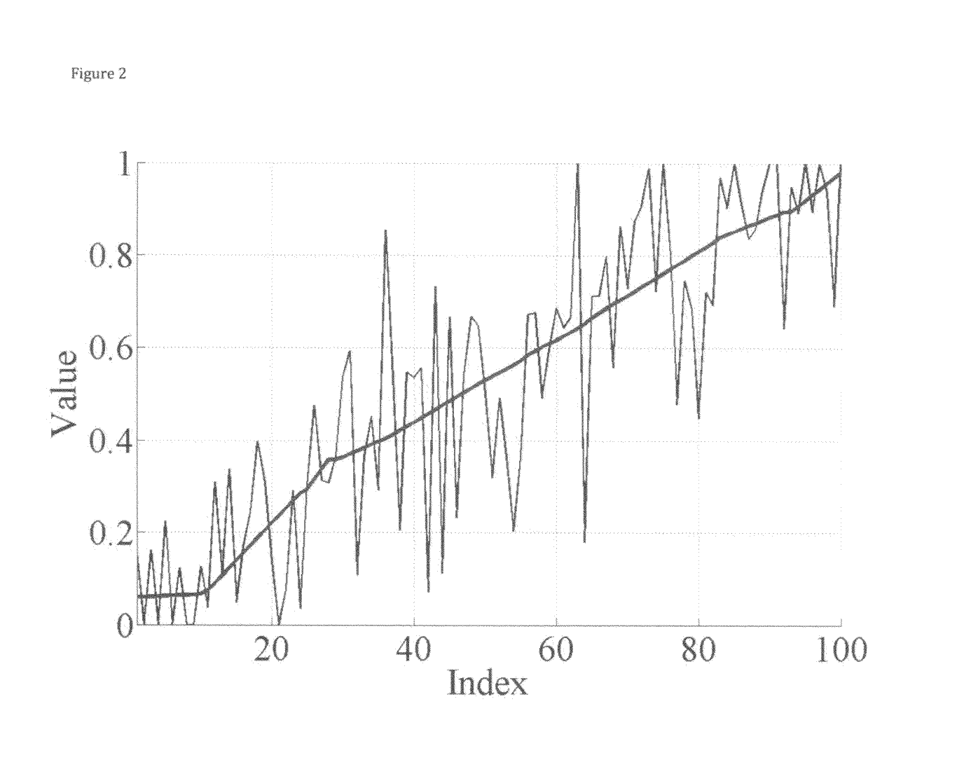

### DETAILED DESCRIPTION

In a typical embodiment, a user may want to build a machine that automatically processes a region of a mammogram to estimate the probability that a cancerous tumor is either present or absent. This is a probabilistic classification problem. The user is attempting to process an input signal x (the mammogram) to estimate the probability of category membership. In this case, there are 2 categories. Category 1 is “present” and category 2 is “absent.” The user begins by building a training sample which consists of input signals and known category labels. Each i-th input signal is a mammogram region, the content of which is characterized by an “input signal” denoted by the vector xᵢ. Each i-th input signal is also associated with a category label (1 or 2) denoted by the variable cᵢ. Once the training sample has been created, MoRPE can be trained on the training sample. After training, MoRPE can implement the decision making process for the user's machine. It will accept a new mammogram region as input and output an estimate of the conditional probability of cancer present or cancer absent. The user can also measure the machine's classification performance in order to measure the power of the statistical relationship that relates mammogram regions with the ability to detect cancer.

Let M denote the number of categories enumerated in the training sample. Let N denote the number of training data from all enumerated categories. Let N_{c} denote the number of training data from category c for any c∈{1, . . . , M}. MoRPE uses K distinct polynomial functions where K (the uppercase Greek letter kappa) is computed as follows.

K=1 for M=2 (4)

K=M for M>2 (5)

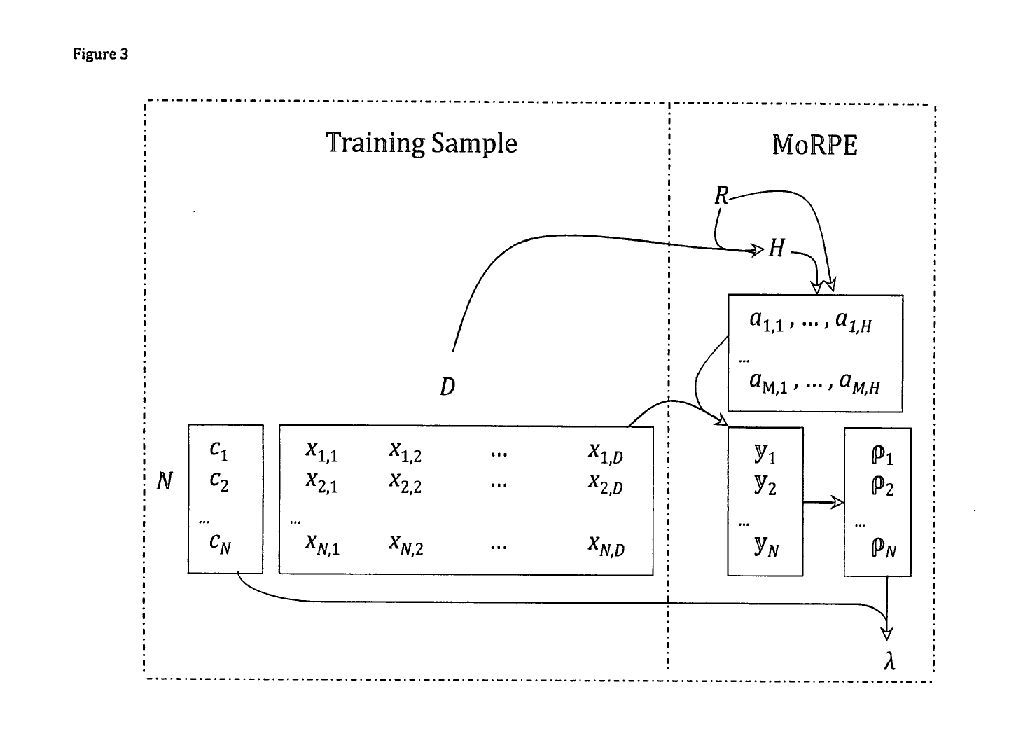

To begin the training epoch, the user must first prepare a training sample. FIG. 3 illustrates the training sample which contains N training data. Each row of the training sample is depicted in FIG. 3 is a training datum. Each i-th training datum consists of (1) a category label cᵢ which represents the output of an omniscient classifier and (2) an input signal vector xᵢ. Let D denote the length of all input signal vectors. The user is obviously free to control the value of D because they already control the nature of the input signal, but MoRPE requires that each input signal be represented as a vector of the same length which is D.

Before training begins, the user may choose the rank of the polynomial that MoRPE will use. The rank of the polynomial is a positive integer denoted as R, the default value of R is 1, and the user can set R to be any positive integer.

Before training begins, the user may change a flag denoted as FORCE_EQUAL_PRIORS. By default, this flag is set to false; but if true, MoRPE will train itself as if each category had equal representation in the training sample.

Before training begins, the user may set the number of quantiles associated with each κ-th polynomial as Q_{κ} which defaults to 10 for all κ∈{1, . . . , K}. Note that κ is the lowercase Greek letter kappa.

MoRPE computes the number of coefficients per polynomial function as H, as shown by equation 4. The i-th coefficient for the κ-th polynomial is denoted as a_{κ,i}. The entire vector of polynomial coefficients for the κ-th polynomial is denoted as a_{κ} which has a length of H.

H=(R+D)!/R!/D! (6)

a_{κ}=(a_{κ,1}, . . . , a_{κ,H}) ∀κ∈{1, . . . , K} (7)

In order for MoRPE to compute y_{κ,i} as a function of the i-th input signal in the training sample, an intermediate vector zᵢ is first defined. The length of each i-th zᵢ is equal to H. The values of each i-th zᵢ are defined entirely from the elements of the corresponding xᵢ using the rank R inhomogeneous polynomial expansion function h_{R}(.). This function outputs zᵢ which is defined as a vector where each element is equal to a unique product (i.e. multiplication) of the terms of xᵢ, where all possible unique products are fully represented across the elements of zᵢ, where the terms in each product are constrained to have integer exponent values within the range of 0 to R inclusive, and where the sum of these exponent values are integers in the range of 0 to R inclusive. Below are examples of this function for ranks of 1, 2, and 3 where we assume that the length of xᵢ is 3 so that xᵢ=(x_{1,i}, x_{2,i}, x_{3,i})^{T} for all i∈{1, . . . , N}.
(R=1) The linear expansion of (x_{1,i}, x_{2,i} , x_{3,i})^{T} is shown below assuming D=3.

zᵢ→h₁(xᵢ)≡(1, x_{1,i}, x_{2,i}, x_{3,i})^{T} (8)
(R=2) The quadratic expansion of (x_{1,i}, x_{2,i}, x_{3,i})_{T} is shown below assuming D=3.

zᵢ→h₂(xᵢ)≡(1, x_{1,i}, x_{2,i}, x_{3,i}, x_{1,i}², x_{2,i}², x_{3,i}², x_{1,i}x_{2,i}, x_{1,i}x_{3,i}, x_{2,i}x_{3,i})^{T} (9)
(R=3) The cubic expansion of (x_{1,i}, x_{2,i}, x_{3,i})^{T} is shown below assuming D=3.

$${z}_{i} -> {h}_{3} ( {x}_{i} ) ≡ {( \begin{matrix}1 , {x}_{1 , i} , {x}_{2 , i} , {x}_{3 , i} , {x}_{1 , i}^{2} , {x}_{2 , i}^{2} , {x}_{3 , i}^{2} , {x}_{1 , i} {x}_{2 , i} , {x}_{1 , i} {x}_{3 , i} , {x}_{2 , i} {x}_{3 , i} \\ {x}_{1 , i}^{3} , {x}_{2 , i}^{3} , {x}_{3 , i}^{3} , {x}_{1 , i}^{2} {x}_{2 , i} , {x}_{1 , i}^{2} {x}_{3 , i} , {x}_{2 , i}^{2} {x}_{1 , i} , \\ {x}_{2 , i}^{2} {x}_{3 , i} , {x}_{3 , i}^{2} {x}_{1 , i} , {x}_{3 , i}^{2} {x}_{2 , i} , {x}_{1 , i} {x}_{2 , i} {x}_{3 , i}\end{matrix} )}^{T} \qquad ( 10 )$$

While the prior three examples assume that D=3 , the polynomial expansion works for any positive integer value of D. This allows MoRPE to define y_{κ,i} for the i-th training sample and κ-th polynomial as the dot product of two vectors, a_{κ} and zᵢ^{T} where the superscript T denotes a vector transpose operation.

y_{κ,i}≡a_{κ}·h_{R}(xᵢ)^{T}=a_{κ}·zᵢ^{T} ∀κ∈{1, . . . , K}, i∈{1, . . . , N} (11)

The vector of y-values for the i-th training sample is denoted as yᵢ and has a length of K.

yᵢ=(y_{1,i}. . . , y_{K,i}) ∀i∈{1, . . . , N} (12)

At the beginning of training, MoRPE can initialize the polynomial coefficients in a number of ways. One way is to pick the coefficients a_{κ} of each κ-th polynomial to be identical to the FQD (see equation 1) so that equation 9 produces a polynomial function of x with coefficients identical to equation 1. However, in the special case where R=1, only the linear coefficients of the FQD are used, effectively forcing the quadratic coefficients of the FQD equal to 0 while the other coefficients (i.e. linear) are not altered. In order to compute the coefficients of each κ-th polynomial using the FQD, MoRPE must first calculate two mean vectors and two covariance matrices, as detailed in the prior description of the FQD. One mean vector and covariance matrix are evaluated using a commonly accepted statistical calculation with respect to the feature vectors in the training sample where the category label is κ. The other mean vector and covariance matrix are evaluated using the standard statistical calculation with respect to the remaining feature vectors in the training sample where the category label is equal to anything but κ. As will be described later, these polynomial coefficients will be optimized with the goal of maximizing the value of λ (defined later).

After the polynomial coefficients are initialized, and each time they are altered during optimization, MoRPE calculates the values of a vector ρᵢ for each i-th training sample. Each of these ρᵢ vectors has a length of M, its values are denoted as (ρ_{1,i}, . . . , ρ_{M,i}), and all of these values are bounded within the range of 0 to 1 exclusive.

During the training process, the vector ρᵢ must be evaluated for each i-th training datum xᵢ for all i∈{1, . . . , N}. During the training process, whenever MoRPE alters the value of a polynomial coefficient (i.e. during parameter optimization), MoRPE must re-evaluate ρᵢ for all i. The calculations that MoRPE uses to evaluate ρᵢ for all i are defined hereafter. The calculation involves many intermediate steps.

If the user had set the flag FORCE_EQUAL_PRIORS equal to false, then we would set a weight-value denoted as w_{c} equal to w_{c}=1 for all c∈{1, . . . , M}; otherwise, if the flag was set equal to true, then w_{c} would be set as shown in the following equation for all c∈{1, . . . , M}.

$$\begin{matrix}{w}_{c} = \frac{1}{{MN}_{c}} {\sum }_{k = 1}^{M} {N}_{k} & ∀ c ∈ \{ 1 , … , M \}\end{matrix} \qquad ( 13 )$$

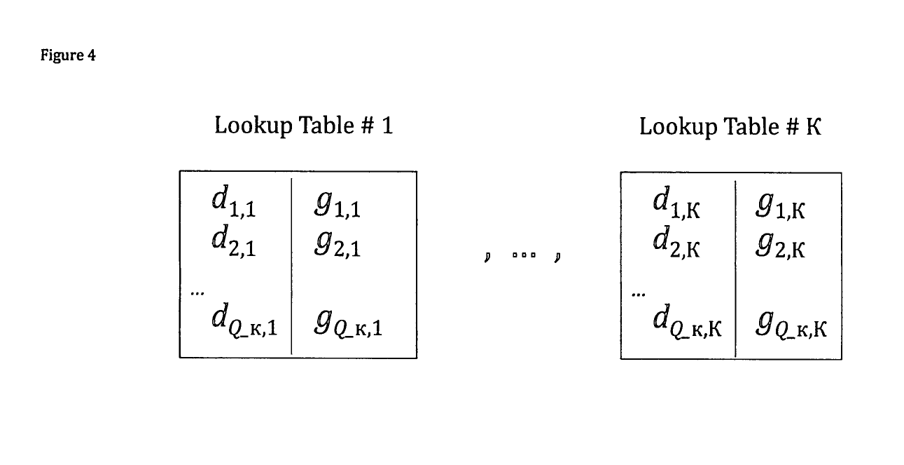

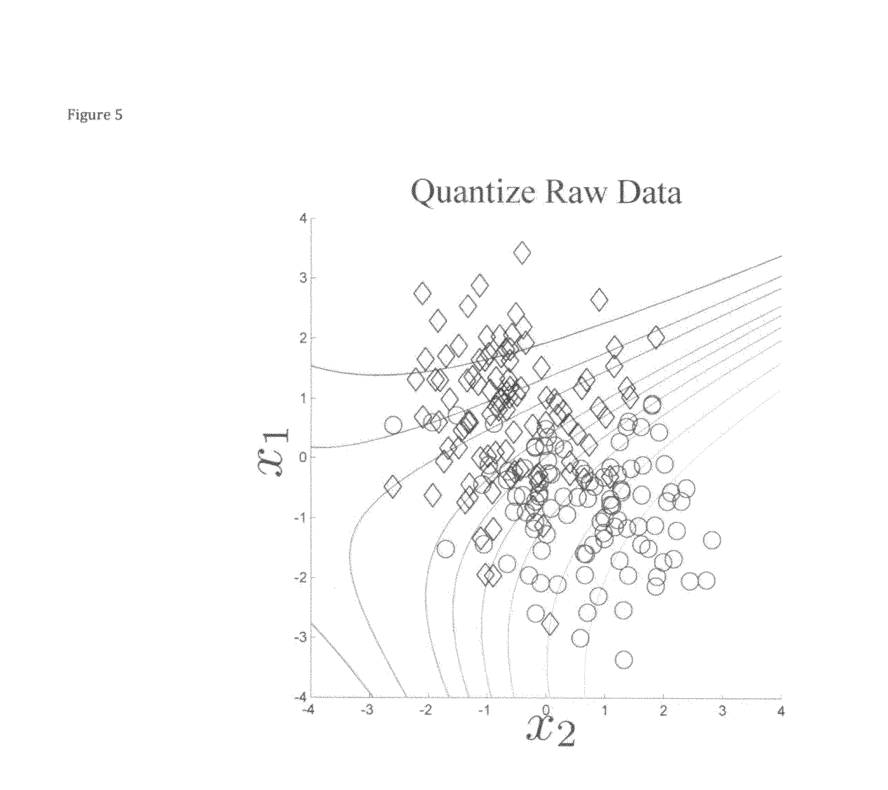

For each i-th member of the training sample where i∈{1, . . . , N}, MoRPE creates ρᵢ by iterating through a sequence of steps K times where κ identifies the step number such that κ∈{1, . . . , K}. Each κ-th iteration focuses on the κ-th polynomial and involves a serial sequence of (1) quantization, (2) monotonic regression, and then (3) linear interpolation of a κ-th lookup table. The lookup tables are illustrated in FIG. 4.

A quantile is a bin that holds a subset of training data, and for each κ-th iteration, the number of quantiles is denoted as Q_{κ}. The number of training data in each quantile is set equal to N/Q_{κ}±1. Quantization occurs as a result of sorting the rows of training data by ascending y_{κ,i}-values and then partitioning the rows of the table into Q_{κ} adjacent quantiles, each of which contains N/Q_{κ}±1 training samples. The resulting quantiles are associated with adjacent but non-overlapping ranges of y_{κ,i}. The centroid of each j-th quantile is denoted as d_{j,κ} and is easily computed as the mean of y_{κ,i}-values within the quantile. After quantization, it is trivial to count the number of samples from category κ in the j-th quantile, and this count is denoted as n_{j,κ}. Similarly, the count for some category c is denoted n_{j,κ}. The following equation shows the next step, which is to calculate \tilde{g}_{j,κ} for all j∈{1, . . . , Q_{κ}} where b is a positive number that defaults to 0.5, where r_{κ} is the proportion of total training samples from category κ, where r_{c} is the proportion of total training samples from some category c. Standard sigma notation is used for summation across all values of c where c∈{1, . . . , M}.

$${\tilde{g}}_{j , κ} ≡ \frac{{w}_{κ} ( {n}_{j , κ} + b {r}_{κ} )}{{\sum }_{c = 1}^{M} {w}_{c} ( {n}_{j , c} + b {r}_{c} )} \qquad ( 14 )$$

The values of \tilde{g}_{j,κ} are assembled into a vector \tilde{g}_{κ} equal to (\tilde{g}_{1,κ}, . . . , \tilde{G}_{Q}_{_{—}}_{κ,κ}). Next, a monotonic regression of \tilde{g}_{κ} is performed to yield g_{κ} for all κ∈{1, . . . , K}. The elements of g are denoted as (g_{1,κ}, . . . , g_{Q}_{_{—}}_{κ,κ}) and are guaranteed by the monotonic regression algorithm to be monotonically increasing such as a function of the first index such that g_{1,κ}<g_{2,κ}, g_{2,κ}<g_{3,κ}, etc. Recall also that the values of d_{j,κ} are also monotonically increasing as a function of the first index such that d_{1,κ}<d_{2,κ}, d_{2,κ}<d_{3,κ}, etc, and these values can be arranged to yield a vector d_{κ} equal to (d_{1,κ}, . . . , d_{Q}_{_{—}}_{κ,κ}). Since the vectors d_{κ} and g_{κ} are both monotonically increasing as a function of vector index, the vectors can be used together to create a lookup table that approximates a smooth one-to-one function for all κ∈{1, . . . , K}. The lookup tables are depicted in FIG. 4. We denote a function I(y_{κ,i}) of y_{κ,i} which performs standard linear interpolation of the lookup table which maps the input y_{κ,i} from the domain of a function approximated by d_{κ} to the domain of a function approximated by g_{κ} where the output of this function is η_{κ,i}.

η_{κ,i}=I_{κ}(y_{κ,i}) (15)

MoRPE evaluates and stores the values of η_{κ,i} for all κ∈{1, . . . , K} and for all i∈{1, . . . , N}, allowing it to easily evaluate ρ_{κ,i} as follows.

$${ρ}_{κ , i} ≡ \frac{{η}_{κ , i}}{{\sum }_{c = 1}^{M} {η}_{c , i}} \qquad ( 16 )$$

In the case of the 2-category problem, ρ_{2,i} is evaluated as equal to 1−ρ_{1,i} for all i∈{1, . . . , N}. The optimization objective value λ is defined as follows

$$λ = {\prod }_{i = 1}^{N} {ρ}_{c\_i , i}^{{w}_{c\_i} / N} \qquad ( 17 )$$

where c_i denotes the category label for the i-th datum in the training sample (depicted as cᵢ in FIG. 3), where ρ_{c}_{_{—}}_{i,i} is consistent with the previous definition of ρ_{κ,i} using a different subscript for the category label, and where w_{c}_{_{—}}ᵢ is consistent with the previous definition of w_{c} using a different subscript for the category label.

To improve computational accuracy, MoRPE actually uses logarithms to evaluate −log λ rather than directly evaluating λ as the previous equation suggests. From a theoretical standpoint, this has no effect on the parameter optimization procedure since maximizing λ is equivalent to minimizing −log λ. We refer to −log λ as “conditional entropy.” MoRPE performs the calculation as follows.

$$- log λ = - \frac{1}{N} {\sum }_{i = 1}^{N} {w}_{c\_i} log ( {ρ}_{c\_i , i} ) \qquad ( 18 )$$

MoRPE employs parameter optimization techniques to find the polynomial coefficients that maximize λ, equivalent to minimizing conditional entropy. Parameter optimization can be accomplished using a variety of techniques that are well known and freely available to experts in the field. When parameter optimization is completed, MoRPE saves the optimized polynomial coefficients and the lookup tables. This marks the end of the training epoch.

After training, the implementation epoch can begin. This means that MoRPE is ready to assign the probability of category membership as a function of any new input signal x provided by the user. During the implementation epoch, MoRPE is not required to reference the training sample. MoRPE simply utilizes the optimized polynomial coefficients and lookup tables that were saved as a result of the training epoch. Utilizing this information, MoRPE performs the procedure that was previously described for processing any single input signal vector x to yield a single output vector ρ. This is a very simple procedure that involves the same steps described for the training epoch, but whereas the training epoch describes how to estimate many ρ-vectors based on many x-vectors, the implementation epoch can assume the sample size is 1 and then evaluate a single vector ρ for any given single vector x. Since the polynomial coefficients are already optimized and fixed, and since the lookup tables have already been calculated and fixed, it is fast and easy to calculate ρ from x during the implementation epoch. MoRPE's output ρ is useful because it is a very good approximation of the conditional probability of category membership as shown below.

ρ=(ρ₁, . . . , ρ_{M})≈[p(1|x), . . . , p(M|x)] (19)

If the flag FORCE_EQUAL_PRIORS had been set to true, then the conditional probabilities in equation 19 would be scaled according to equations 13 and 14, but it is obvious to any expert in the field how this scaling could be removed.

### Alternative Embodiments

MoRPE is a general method that operates across a general class of problems. It can be used to design and implement a computational algorithm that makes automatic decisions based on sensory input signals or other data input signals. For example, it can be used to detect targets in sections or regions of movies, images, or audio files. It can be used to design robotic sensory systems. It can be used by medical equipment to detect the presence of anomalies, disease, or arbitrary targets. It can be used to classify behaviors or to recognize objects and individuals based on any kind of sensory input signals.

In order for MoRPE to be applied to any problem, the basic requirement is the existence of a training sample that consists of input signals correctly matched to category labels.

### Advantages

MoRPE has an unprecedented ability to approximate an optimal probabilistic classifier with remarkable precision and reliability in common scenarios. MoRPE is reliable because it uses quantization to estimate probability. This is important because quantization (or counting) is perhaps the only direct method of measuring probability.

MoRPE leverages a “decision function” of x into a probability of category membership for any given x. Incredibly, any monotonic transformation of the decision function will not affect MoRPE's performance in any way (assuming the monotonic transform is applied in the training epoch and carried through to the implementation epoch). This same property is remarkably important because it provides MoRPE with a huge advantage over other methods. MoRPE does not need to find a specific decision function of x because any monotonic transform of the function will yield equivalent performance.

MoRPE also utilizes the inhomogenous polynomial expansion to manage sampling noise in an efficient way. Critically, the lowest ordered parameters respond to the lowest ordered moments of the category distributions. At the same time, these lowest ordered moments convey information that tends to be the most resistant to sampling noise under a reasonable set of assumptions. Specifically, if we assume that the user has designed the feature space so that each category has a small number of modes where density falls regularly from each mode, then the lowest ordered moments will carry most of the useful information for classification.

MoRPE uses the optimization objective known as “conditional entropy minimization,” also called “maximizing λ.” This optimization objective has remarkable benefits, but only because it is highly compatible with other aspects of MoRPE. The optimization objective adds a layer of robustness by increasing MoRPE's resistance to sampling error or sampling noise. This only works for MoRPE because MoRPE's estimate of probability is very well calibrated, and during the training procedure, MoRPE's evolving estimate of probability will yield relatively minor ripples across the otherwise convex optimization surface.

MoRPE is well suited to classification problems where the number of categories is greater than 2. Other methods have difficulty handling more than two categories. Typically, when methods handle more than 2 categories, they produce serious errors. In contrast, MoRPE is well suited to handle problems with multiple categories. It inherits this ability because of its ability to produce extremely precise estimates of conditional probability for the 2-category problem.

### Limitations

MoRPE has three primary limitations. First, like all comparable methods, it approximates the optimal classifier for a given formulation of x, but not all possible formulations of x. When a user applies the method, they have freedom to formulate x however they choose. In many (perhaps most) applications, x is a simple representation of a more complex signal. In such cases, the number of arbitrary ways to formulate x can be infinite. This potentially limits the generality of results obtained for a specific formulation of x, making any such result dependent upon the user's arbitrary formulation of x. However, this limitation can be partially overcome via a guess and check procedure. In such a procedure, the user can guess a specific formulation of x, then check its level of performance. Obviously, the procedure's goal is to find the formulation of x that leads to the best possible performance, and this is usually measured by the standard technique of cross-validation which is familiar to experts in the field. With enough skillful guesswork, the guess and check procedure should uncover a nearly optimal formulation of x.

Second, as previously discussed, the new method guarantees that for a given data set, classifier performance is equivalent for all possible affine transformations on x. However, arbitrary non-affine transformations can still influence classifier performance. Therefore it may be important to consider the effects of reformulating x via arbitrary non-affine transformations. This consideration can be built into the guess and check procedure. A successful non-affine transformation of x should minimize category fragmentation in the feature space. In other words, the goal of the non-affine transform should be to render a category structure in x-space with a small number of modes where category density falls regularly from each mode. At the same time, dimensionality of the x-space should be limited to only those feature dimensions that are relevant for classification.

Third, for the new method, the training of free parameters is not a convex optimization problem. This means that in common scenarios, it is necessary to employ moderate computational brute-force to reveal parameters that are nearly optimal. While not totally convex, the surface of λ has relatively smooth and minor ripples across the parameter space, making the optimization problem tractable in many common scenarios.

1. A machine that facilitates the estimation of probabilities of nominally labeled phenomena such as discrete outcomes, events, or categories; where the estimation of said probabilities is facilitated by processing data received from an input component or sensory device.

2. The system of claim 1 that learns to improve the quality of its estimates by referring to a sample of data that was previously received, where each datum within said sample is correctly matched to one nominally labeled phenomena or where correct matching can be assumed by the user.

3. The system of claim 2, where learning is mediated by processing the sample of previously received data by computing a value or values for each datum, by quantizing or binning these values, by tallying the presence of each nominally labeled phenomena within each quantile or bin, and by performing monotonic regression of proportioned tallies.

4. The system of claim 3, where upon completion of learning, the system can estimate probabilities of nominally labeled phenomena by processing data received from an input component or sensory device.

5. The system of claim 4, which can facilitate the investigation of statistical relationships in data that has been matched to nominally labeled phenomena, including the nature, magnitude, and statistical significance of said relationships.

6. The system of claim 5, which can be used to design new systems, machines, processes, or methods that process data to estimate the probability of a nominally labeled phenomena.

7. The system of claim 6, which can be used to design new systems, machines, processes, or methods that operate by combining many estimates of probabilities for nominally labeled phenomena.

8. A process or method that facilitates the estimation of probabilities of nominally labeled phenomena such as discrete outcomes, events, or categories; where the estimation of said probabilities is facilitated by processing data or received from an input component or sensory device.

9. The system of claim 8 that learns to improve the quality of its estimates by referring to a sample of data that was previously received, where each datum within said sample is correctly matched to one nominally labeled phenomena or where correct matching can be assumed.

10. The system of claim 9, where learning is mediated by processing the sample of previously received data by computing a value or values for each datum, by quantizing or binning these values, by tallying the presence of each nominally labeled phenomena within each quantile or bin, and by performing monotonic regression of the tallies.

11. The system of claim 10, where upon completion of learning, the system can estimate probabilities of nominally labeled phenomena by processing data received from an input component or sensory device.

12. The system of claim 11, which can facilitate the investigation of statistical relationships in data that has been matched to nominally labeled phenomena, including the nature, magnitude, and statistical significance of said relationships.

13. The system of claim 12, which can be used to design new systems, machines, processes, or methods that process data to estimate the probability of a nominally labeled phenomena.

14. The system of claim 13, which can be used to design new systems, machines, processes, or methods that operate by combining many estimates of probabilities for nominally labeled phenomena.
